(19) United States
(12) Patent Application Publication
(10) Pub. No.: US 2018/0003106 A1
(43) Pub. Date: Jan. 4, 2018

(54) Pivoting Piston Machine

(71) Applicant: Innowatt GmbH, Steinen (DE)

(72) Inventor: Herbert Huettlin, Steinen (DE)

(73) Assignee: Innowatt GmbH, Steinen (DE)

(21) Appl. No.: 15/702,365

(22) Filed: Sep. 12, 2017

Related U.S. Application Data
(63) Continuation of application No. PCT/EP2016/055014, filed on Mar. 9, 2016.

(30) Foreign Application Priority Data
Mar. 13, 2015 (DE) 102015103734.3

(51) Int. Cl. F02B 53/06; F01L 1/04; F01L 1/344; F02B 53/14

(52) U.S. Cl. CPC F02B 53/06; F01L 1/344; F01L 1/04; F02B 53/14

(57) ABSTRACT

A pivoting piston machine includes a housing, a first piston and a second piston arranged in the housing, the first and second pistons being pivotable away from one another and toward one another about a pivot axis. The machine has a working chamber arranged between first and second piston. The working chamber increases and decreases in size in alternating fashion during pivoting of the first piston and of the second piston. The machine also has a inlet mouth for admission and discharge of the working medium. A closing element for closing and opening the inlet or the outlet has a valve disk interacting with a valve seat. Either the inlet mouth or the outlet mouth is arranged within the working chamber between the first end surface and the second end surface, and the valve seat and the valve disk are arranged at either the inlet mouth or the outlet mouth.

### CROSS-REFERENCES TO RELATED APPLICATIONS

This application is a continuation of international patent application PCT/EP2016/055014, filed on Mar. 9, 2016 designating the U.S., which international patent application has been published in German language and claims priority from German patent application 10 2015 103 734.3, filed on Mar. 13, 2015. The entire contents of these priority applications are incorporated herein by reference.

### BACKGROUND OF THE INVENTION

The invention relates to a pivoting piston machine, having a housing in which a first piston and a second piston are arranged, which are pivotable away from one another and toward one another about a pivot axis, wherein the first piston has a first end surface and the second piston has a second end surface, wherein a working chamber for a working medium is arranged between the first end surface and the second end surface, which working chamber increases and decreases in size in alternating fashion during the pivoting of the first piston and of the second piston, wherein an inlet for the admission of working medium into the working chamber, and an outlet for the discharge of working medium out of the working chamber, open into the working chamber, and having a closing element for closing and opening up at least the inlet or at least the outlet, wherein the closing element has a valve disk which interacts with a valve seat.

A pivoting piston machine as per the present invention may be formed purely as a combustion engine, or as a combustion engine combined with an electromotive part (as a generator or as a hybrid motor), and/or as a compressor.

A pivoting piston machine differs from classic reciprocating-piston machines by the fact that the pistons perform not a linear stroke movement but rather pivoting movements about a pivot axis. This makes it possible for the entire pivoting piston machine to be formed with a spherical housing, as is also realized in the case of the pivoting piston machine known from document DE 10 2007 039 309 A1. In the case of the known pivoting piston machine, the pivoting movements of the pistons are derived from the revolving movement thereof about the axis of rotation.

In the case of a pivoting piston machine of said type being used as a combustion engine, the individual working strokes of intake, compression, expansion and exhaust are realized by means of backand-forth movements of at least two pistons between two end positions, the so-called BDC (bottom dead center) and TDC (top dead center) positions.

In the case of a pivoting piston machine being used as a compressor, the mode of operation is similar, wherein, however, no combustion process takes place in the pivoting piston machine, and accordingly no ignition of a combustion mixture takes place, it rather merely being the case that a gas, in particular air, is compressed to high pressure.

In the case of the embodiment of a pivoting piston machine as a generator, said pivoting piston machine constitutes a combination of a combustion engine with an electromotive part, wherein the work performed by the pistons is utilized for driving the electromotive part and thus for generating electrical energy. Here, the electromotive part is likewise accommodated in the housing of the pivoting piston machine, as is described for example in the document WO 2011/147492 A2. With a similar construction to a generator, the pivoting piston machine can also be used as a hybrid motor, as is likewise described in document WO 2011/147492 A2.

Regardless of the function of the pivoting piston machine as a pure combustion engine, as a compressor, as a generator or as a hybrid motor, a working chamber is provided between at least in each case two pistons, into which working chamber a working medium is admitted, and from which said working medium is discharged or expelled again, in a periodic sequence. Correspondingly, the working chamber is assigned an inlet for the admission of working medium into the working chamber and an outlet for the discharge of working medium out of the working chamber, which inlet and outlet each open into the working chamber.

In the case of the pivoting piston machine known from document DE 10 2007 039 309 A1, the inlet and the outlet have a common mouth into the working chamber, which mouth is situated at the outer edge of the working chamber. In relation to the geometric axis of rotation about which the pistons perform a revolving movement superposed on their pivoting movement, said mouth is arranged on a face side of the housing, that is to say on the axis of rotation and perpendicular to the latter. For the closing and opening-up of the mouth, a closing element is provided which is formed in the manner of a classic tulip valve and correspondingly has a valve disk which interacts with a valve seat at the edge of the mouth. During their pivoting movements, the pistons move, as viewed in relation to the pivot axis, radially within the mouth and thus the valve disk, toward one another, as shown in FIG. 3 in DE 10 2007 039 309 A1. The control of the opening and closing of the closing element is in this case derived, by means of a control drive, from the revolving movement of the pistons about the axis of rotation.

It could be considered to be a disadvantage of said pivoting piston machine that the admission and discharge of the working medium into and out of the working chamber takes place via a common mouth, in which the abovementioned closing element is arranged. In this way, overlaps, that is to say temporally overlapping simultaneous opening-up of the outlet and of the inlet, such as are provided and have proven to be expedient in modern engine control regimes, are not possible.

The pivoting piston machine known from the above-cited document WO 2011/147492 A2 has a valveless, rotary-slide-like controller for the admission of working medium into the working chamber and the discharge of working medium out of the working chamber. This is realized by virtue of the pistons being arranged in a piston cage which, on a face side, has a gas exchange opening which, during the common revolving movement with the pistons, alternately communicates with an inlet opening and with an outlet opening in a face part of the housing. It could be considered to be a disadvantage of this embodiment that the opening and closing times of fresh-gas inlet and exhaust gas outlet cannot be set in a load-dependent and/or rotational-speed-dependent manner. For the operation of the pivoting piston machine with constant rotational speeds, as is the case for example in the case of use as a generator, a rotational-speed-dependent adjustment of the gas exchange controller is also not necessary.

It can thus be stated that the known pivoting piston machines are, inter alia owing to their compactness, highly suitable for a large number of usage situations, but have room for improvement with regard to the configuration of their gas exchange control.

### SUMMARY OF THE INVENTION

Against this background, it is an object of the invention to provide a pivoting piston machine of the type mentioned in the introduction which exhibits improved gas exchange control.

According to the invention, a pivoting piston machine is provided, comprising a housing, a first piston and a second piston arranged in the housing, the first and second pistons being pivotable away from one another and toward one another about a pivot axis, the first piston having a first end surface and the second piston having a second end surface, a working chamber for a working medium arranged between the first end surface and the second end surface, the working chamber increasing and decreasing in size in alternating fashion during pivoting of the first piston and of the second piston, an inlet having an inlet mouth for admission of working medium into the working chamber, and an outlet having an outlet mouth for discharge of working medium out of the working chamber, the inlet and the outlet opening into the working chamber, a closing element for closing and opening up one of the inlet or the outlet, the closing element having a valve disk interacting with a valve seat, wherein at least one of the inlet mouth and the outlet mouth is arranged within the working chamber between the first end surface and the second end surface, and wherein the valve seat and the valve disk are arranged at one of the inlet mouth or the outlet mouth.

In the case of the pivoting piston machine according to the invention, by contrast to the known pivoting piston machine mentioned in the introduction, the mouth at least of the inlet or at least of the outlet is thus situated within the working chamber between the two end surfaces of the two pistons, that is to say, in the TDC position of the pistons, within the circumferential edges of the end surfaces of the pistons. The relocation of the mouth from the outer edge of the working chamber, as in the prior art, into the working chamber offers numerous advantages in terms of fluid mechanics, in particular faster and more uniform charging of the working chamber and/or faster evacuation of the working chamber. If the mouth at least of the inlet is arranged in the working chamber, admitted working medium, for example fresh air, can be distributed more uniformly in the working chamber, that is to say the working medium can enter the working chamber over approximately equal distances in all directions. There are therefore no distances of unequal length for the working medium entering the working chamber, as is the case in the known pivoting piston machine.

Furthermore, the embodiment according to the invention makes it possible to provide a separate mouth for the inlet and a separate mouth for the outlet in the working chamber between the two end surfaces of the two pistons, as is provided in a preferred embodiment of the invention that will be described in more detail below. The pivoting piston machine according to the invention therefore makes it possible to implement gas exchange control with time overlaps of the admission and discharge without increased outlay in terms of construction.

The mouth at least of the inlet or at least of the outlet can also, by means of the invention, be designed to be large enough that, when the valve disk is open, a ring-shaped gap of large circumference is formed, which has a positive effect on the gas exchange.

In a preferred embodiment, the valve disk extends parallel to a pivot plane of the first and second piston.

In this embodiment, there is not only the advantage that the mouth can be of large-caliber design, but also the advantage that the end surfaces of the pistons can be provided with a concave, even hemispherical-shell-shaped form, such that the working chamber is enlarged in the shape of a hollow sphere when the pistons pivot apart from one another. This in turn has the advantage of a particularly uniform distribution of the admitted working medium in the working chamber during the admission (intake) process.

It is furthermore preferred if the valve disk is movable parallel to the pivot axis for the closing and opening-up of the mouth.

Here, it is advantageous that the valve disk may be equipped with a valve drive shank without this colliding with the pivotable pistons.

In a further preferred refinement, a respective contour of the first and of the second end surfaces is adapted to an outer contour of a circumferential edge of the valve disk, such that the first and/or the second end surface surround the valve disk in a form-fitting manner when the working chamber has its minimum volume.

In this embodiment, the end surfaces of the pistons are optimally adapted to the valve disk. In the TDC position, said end surfaces may preferably assume a spacing of 0.5 mm from the circumferential edge of the valve disk.

In a further preferred embodiment, the first piston and the second piston are arranged in a piston cage arranged in the housing, wherein the piston cage has an externally convexly curved bell-shaped section, the working-chamber-side opening of which forms the mouth of the inlet or of the outlet.

Here, the bell-shaped section projects into the working chamber, that is to say into the space between the two end surfaces of the two pistons, and serves for accommodating the valve disk. The inlet duct or the outlet duct runs through the bell-shaped section. In particular if the bell-shaped section is, as is preferably provided, formed in one piece with the piston cage, no sealing measures are necessary on the piston cage, whereby the outlay in terms of construction is kept low. Then, the sealing of the working chamber with respect to the interior space of the bell-shaped section is effected only by the valve disk in interaction with the valve seat at the mouth of the bell-shaped section when the closing element is closed.

“Bell-shaped section” is to be understood to mean that the outer contour of said section widens with a convex curvature toward the working-chamber-side opening. Here, the outer contour may be of substantially hemispherical form.

In conjunction with the abovementioned measure, it is furthermore preferable if the first end surface and the second end surface are concavely curved and are adapted to an outer contour of the bell-shaped projection, such that the first and the second end surface surround the bell-shaped projection in a form-fitting manner when the working chamber has its minimum volume.

This measure is particularly advantageous because the end surfaces can, in a manner adapted to the shape of the bell-shaped section, be provided with a hollow form, in particular the form of in each case one half of a hollow sphere. Together, the two end surfaces of the pistons then form a working chamber which, as the pistons pivot apart from one another proceeding from the TDC position, opens in the manner of a hollow sphere. This yields a uniform propagation of the working medium, which is expedient in terms of fluid mechanics, during the admission and expansion processes, and a rapid and complete evacuation during the discharge process.

The bell-shaped section of the piston cage may be equipped with cooling medium ducts in its wall, for the purposes of cooling the bell-shaped section in the working chamber.

In a further preferred embodiment, the mouth is a first mouth of the inlet, the closing element is a first closing element for closing and opening up the first mouth, the valve disk is a first valve disk, and the valve seat is a first valve seat, and a second closing element is provided for closing and opening up a second mouth of the outlet, which second mouth is arranged between the first end surface and the second end surface, wherein the second closing element has a second valve disk which interacts with a second valve seat at the second mouth, wherein the second valve disk is arranged so as to be situated opposite the first valve disk.

This embodiment is particularly advantageous because the inlet and the outlet have separate mouths in the working chamber, which mouths can be closed and opened up independently of one another by means of two separate closing elements. In this way, in particular, temporal overlaps in the opening-up both of the inlet and of the outlet are possible, such as are provided and demanded in the case of modern engine control regimes.

In conjunction with the embodiment mentioned above, the first valve disk and the second valve disk are, in their mutual closed position, arranged spaced apart from one another symmetrically with respect to a geometric axis which runs centrally through the working chamber and perpendicular to the pivot axis.

In the mutual closed position of the two closing elements for inlet and outlet and in the TDC position of the two pistons, the working chamber is thus defined by the space between the two valve disks. During the opening-up of the inlet, a ring-shaped gap is formed, as has already been described above, through which ring-shaped gap fresh gas flows in a central-circumferential and uniformly distributed manner into the working chamber while the pistons pivot from the TDC position into the BDC position. During the later expansion, after the pistons have pivoted into the TDC position again, the ignited mixture can likewise expand uniformly in all directions. In particular in conjunction with the concave design of the end surfaces of the two pistons, a combustion chamber is thus formed in which the combustion mixture can optimally propagate in the shape of a hollow sphere. It is however also the case during the discharge of the burned mixture that the same advantages of a fast discharge of the exhaust gas through the outlet after the opening of the closing element at the outlet are obtained.

In conjunction with the concave curvature of the two end surfaces of the two pistons, a working chamber which opens in the manner of a hollow sphere is realized, which constitutes an ideal expansion chamber after the ignition of the air-fuel mixture.

A spacing of the first valve disk from the second valve disk in the mutual closed position preferably amounts to less than approximately 1 cm, preferably less than approximately 0.8 cm, and more preferably amounts to approximately 0.5 cm or less.

As already mentioned above, the minimum volume of the working chamber in the TDC position of the two pistons is formed by the space between the two opposite valve disks. A spacing of the two valve disks in the abovementioned range is sufficient for an expedient compression ratio prior to the ignition.

In a further preferred embodiment, in the housing, there is arranged a ring-shaped curve element which has a control curve, wherein the curve element can revolve in the housing about an axis of rotation which runs perpendicular to the pivot axis, wherein the first piston and the second piston have in each case one running member, which running members are guided along the control curve in order to derive the pivoting movement of the first and second piston from the revolving movement of the curve element.

This measure, which is already known per se in the case of the pivoting piston machine as per WO 2011/147492 A2, has the advantage in conjunction with the embodiment of the pivoting piston machine according to the invention that the closing elements, which according to the invention are arranged between the end surfaces of the pistons in the working chamber do not have to be subjected to a rotational movement. In this way, the outlay in terms of construction for the pivoting piston machine according to the invention is considerably reduced. For the rotatable curve element, inexpensive rotary bearings are sufficient. Also, in this embodiment, the pistons and the abovementioned piston cage are accommodated in non-rotating fashion in the housing, which has the advantage that no centrifugal forces act on said parts.

Furthermore, a valve controller for controlling the closing element is preferably provided, which valve controller is formed as a cam-type controller with a rotatable cam which interacts with a plunger connected to the valve disk, wherein the cam is driven by the curve element.

The curve element thus advantageously combines two functions, specifically firstly that of imparting the pivoting movement of the pistons and secondly that of controlling the one or more closing elements for the gas exchange in a manner synchronized with the revolving speed of the curve element.

In an embodiment of this measure which is simple in terms of construction, the curve element has, for this purpose, a toothed ring equipped with a first toothing, and the cam has a toothed wheel equipped with a second toothing, wherein the first toothing is in meshing engagement with the second toothing.

Here, the first toothing may be formed substantially as a longitudinal toothing, and the second toothing may be formed substantially as a transverse toothing. In order that, during a rotation of the curve element through 360° about the axis of rotation, the cam likewise rotates through 360°, the number of teeth of the first toothing is equal to the number of teeth of the second toothing.

The valve controller is preferably adjustable for the purposes of setting a closing time and/or an opening-up time and/or a stroke of the closing element in a manner dependent on load and/or rotational speed.

This refinement makes allowance for the requirement for a load-dependent and/or rotational-speed-dependent adjustment of the inlet and outlet times, and also permits overlaps in the opening-up of the inlet and of the outlet, which is made possible for the first time by the present invention.

In an embodiment which is simple in terms of construction, for this purpose, an angular position of the cam relative to the toothed wheel is adjustable.

The adjustment of the cam relative to the toothed wheel may be realized by means of an electric actuator means, or purely mechanically by means of a play between the cam and the toothed wheel, which effects an adjustment of the angular position of the cam relative to the toothed wheel in a manner dependent on load and rotational speed.

As an alternative to a cam-type controller of the one or more closing elements, a purely electrical-electronic controller of the one or more closing elements is also possible.

In a further preferred refinement, a third piston with a third end surface and a fourth piston with a fourth end surface are arranged in the housing, which third piston and fourth piston between them form a second working chamber for a working medium. In this embodiment, the pivoting piston machine according to the invention thus preferably has four pistons. The third and the fourth piston are in this case pivotable about the same pivot axis as the first and the second piston. The first and the third piston are preferably rigidly connected to one another, as are the second piston and the fourth piston, in such a way that the second working chamber decreases in volume when the first working chamber increases in volume, and vice versa.

In this refinement, in each case one combustion cycle can take place in the two working chambers. It is however likewise possible and advantageous if one working chamber is utilized as a combustion chamber for the working strokes of a combustion cycle, whereas the other working chamber is utilized as a compressor. In this case, the pivoting piston machine is a combination of combustion engine and compressor in one common, preferably spherical housing.

In a further preferred embodiment, the abovementioned curve element forms the rotor of an electromotive part, wherein the associated stator of the electromotive part is arranged in the housing so as to be fixed with respect to the housing. In this embodiment, the pivoting piston machine according to the invention can be used as a generator or as a hybrid motor.

Further advantages and features will emerge from the following description and from the appended drawing.

It is self-evident that the features mentioned above and the features yet to be discussed below may be used not only in the respectively specified combination but also in other combinations or individually without departing from the scope of the present invention.

### BRIEF DESCRIPTION OF THE DRAWINGS

An exemplary embodiment is illustrated in the drawing and will be described in more detail with reference thereto below. In the drawing:

FIG. 1 shows a pivoting piston machine in a perspective, partially sectional halved view, wherein the section plane extends along an axis of rotation of a curve element of the pivoting piston machine and perpendicular to a pivot axis of pistons of the pivoting piston machine;

FIG. 2 shows the pivoting piston machine in FIG. 1 in a side view, partially in section, wherein the pistons are shown not in section;

FIG. 3 shows the pivoting piston machine in the same side view as in FIG. 2, wherein, however, the pistons are now in a different pivoting position;

FIG. 4 shows the pivoting piston machine in FIGS. 1 to 3 in a section along a plane which is rotated through 90° about the axis of rotation of the curve element in relation to the section plane in FIGS. 2 and 3;

FIG. 5 shows the combustion-engine part of the pivoting piston machine in the preceding figures in a perspective illustration in the state dismounted from the housing;

FIG. 6 shows a side view of the piston cage in FIG. 5, with the pistons and further elements in FIG. 5 having been omitted;

FIG. 7 shows the piston cage in FIG. 5 in a perspective section along a plane perpendicular to the pivot axis of the pistons;

FIG. 8 shows the piston cage in FIG. 6 in an illustration divided into two halves;

FIG. 9 shows a detail of the pivoting piston machine in FIG. 1, which shows a closing element for the outlet and a closing element for the inlet, wherein the two closing elements are in their closed position;

FIG. 10 shows the detail in FIG. 9, wherein the closing element for the inlet is open, whereas the closing element for the outlet is closed;

FIG. 11 shows the detail in FIG. 9, wherein the closing element for the outlet is open, whereas the closing element for the inlet is closed; and

FIG. 12 shows the detail in FIG. 9, wherein the closing element for the inlet and the closing element for the outlet are partially open.

### DESCRIPTION OF PREFERRED EXEMPLARY EMBODIMENTS

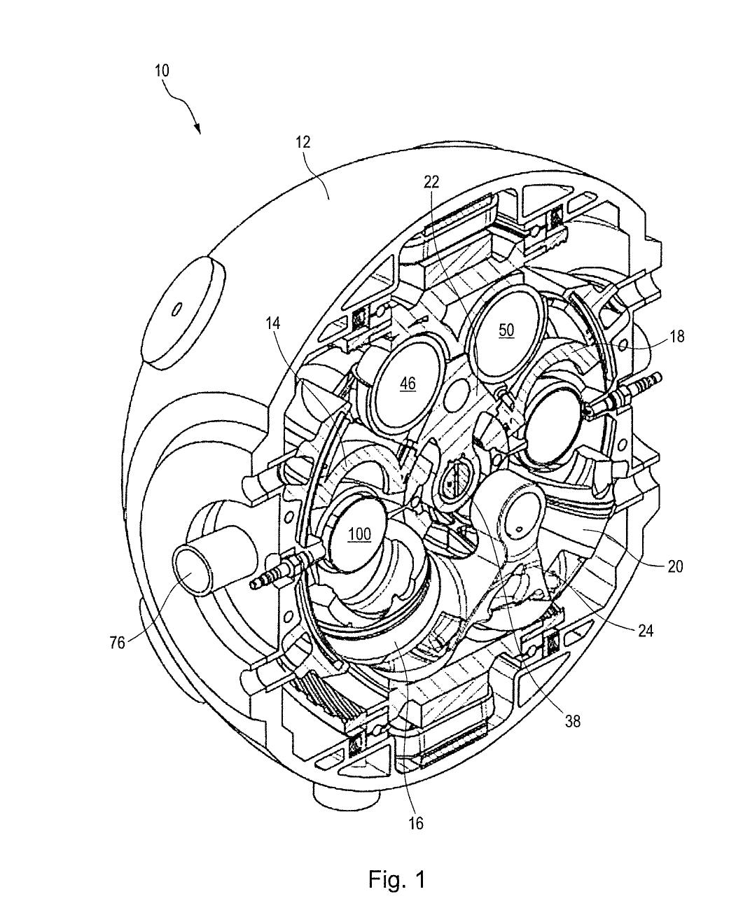

FIGS. 1 to 4 show a pivoting piston machine, denoted by the general reference label 10, in various views.

In the present exemplary embodiment, the pivoting piston machine 10 is designed for use as a combustion engine in combination with an electromotive part, and can thus be used as a hybrid apparatus for driving a motor vehicle. The pivoting piston machine 10 can, in slightly modified form, also be used as a generator or compressor.

With reference to FIGS. 1 to 4, the basic construction of the combustion-engine part of the pivoting piston machine 10 will firstly be described.

The pivoting piston machine 10 has a housing 12, of which one half is shown in FIG. 1. The housing 12 has, overall, the general shape of a sphere, which is correspondingly joined together from two hemispheres.

A first piston 14, a second piston 16, a third piston 18 and a fourth piston 20 are arranged in the housing 12.

The pistons 14, 16, 18 and 20 have a curved cylindrical shape. In cross section, the pistons 14, 16, 18 and 20 have a circular outer contour.

The first piston 14 and the third piston 18 are rigidly connected to one another by means of a connecting section 22. Likewise, the second piston 16 and the fourth piston 20 are rigidly connected to one another by means of a connecting section 24.

The first piston 14 has an end surface 26, the second piston 16 has an end surface 28, the third piston has an end surface 30, and the fourth piston has an end surface 32.

A first working chamber 34 is situated between the first end surface 26 of the first piston 14 and the second end surface 28 of the second piston 16. A second working chamber 36 is situated between the end surface 30 of the piston 18 and the end surface 32 of the piston 20.

The pistons 14, 16, 18 and 20 are pivotable about a common pivot axis 38, which is to be understood as a geometric axis. Owing to the rigid coupling of the piston 14 and of the piston 18, said two pistons perform pivoting movements in the same direction about the pivot axis 38, and likewise, the pistons 16 and 20, owing to their rigid coupling, perform pivoting movements in the same direction. By contrast, the pistons 14 and 16 perform oppositely directed pivoting movements, that is to say the pistons 14 and 16 are pivotable toward one another and away from one another. The same applies to the pistons 18 and 20.

Correspondingly to the pivoting movements of the pistons 14 and 16 toward one another and away from one another, the working chamber 34 periodically increases and decreases in size. Likewise, the working chamber 36 between the end surfaces 30 and 32 of the pistons 18 and 20 periodically increases and decreases in size.

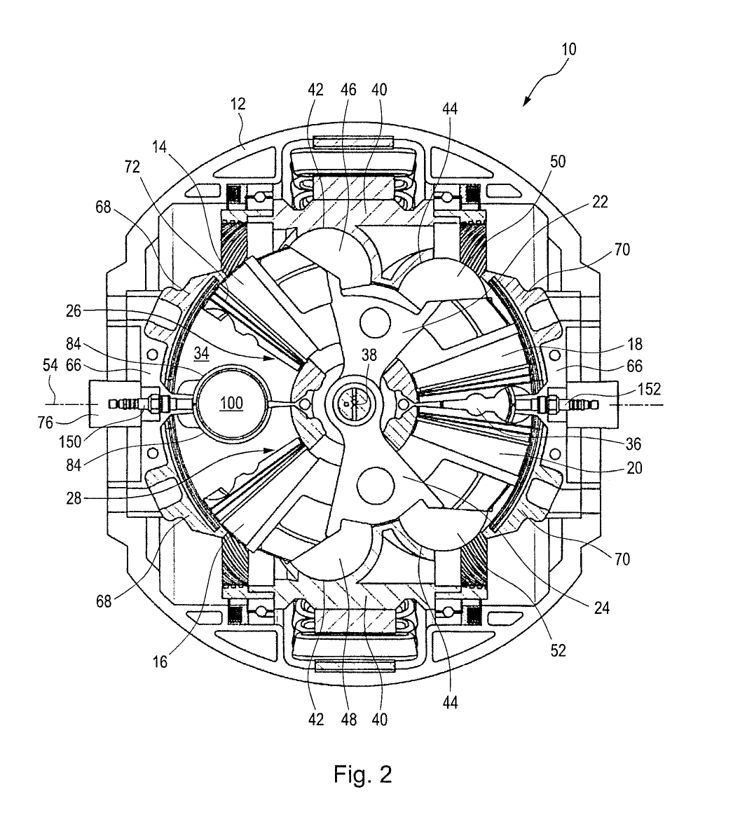

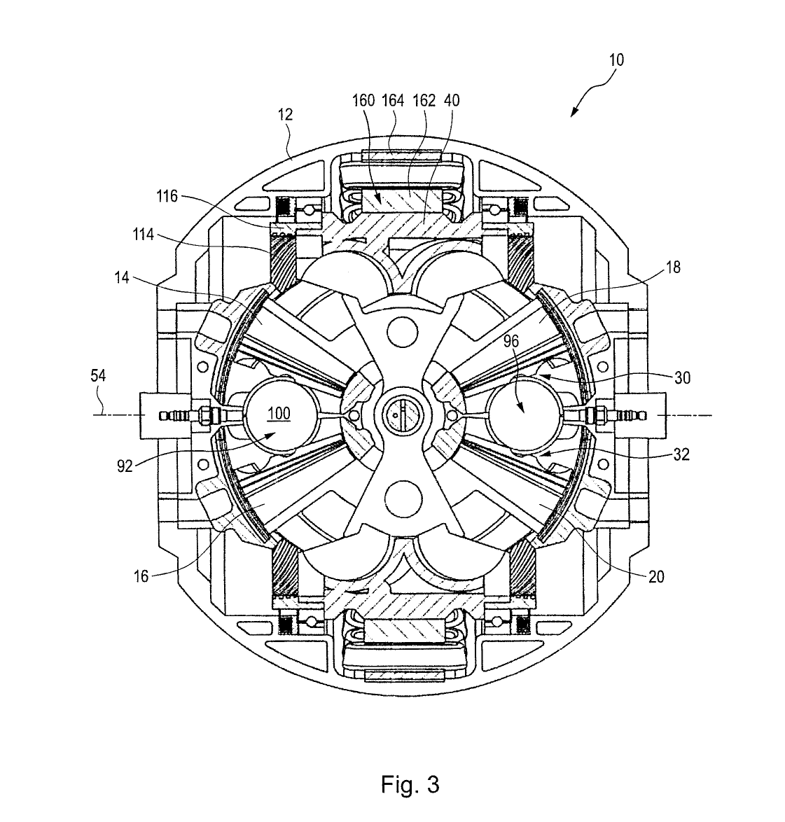

FIG. 2 shows a pivoting position of the pistons 14 and 16 in their BDC position, in which the working chamber 34 has its maximum or approximately maximum volume, and a pivoting position of the pistons 18 and 20 in their TDC position, in which the working chamber 36 has its minimum or approximately minimum volume. The working chambers 34 and 36 thus increase and decrease in size oppositely to one another. FIG. 3 shows a pivoting position of the pistons 14, 16, 18, 20 in which the working chambers 34 and 36 are opened to the same extent. Proceeding from this pivoting position, the working chamber 34 decreases in size and the working chamber 36 increases in size, until the working chamber 36 assumes its maximum volume and the working chamber 34 assumes its minimum volume. This is followed by the reverse process, until the state in FIG. 2 is reached again, etc.

To control the pivoting movements of the pistons 14, 16, 18 and 20, the pivoting piston machine 10 has, in the housing 12, a curve element 40 which has a first control curve 42 and a second control curve 44. The curve element 40 is in the form of a ring extending over the full circumference, and the two control curves 42 and 44 extend over the full circumference on the curve element.

The pistons 14, 16, 18 and 20 each have a running member, and specifically, the piston 14 has a running member 46, the piston 16 has a running member 48, the piston 18 has a running member 50 and the piston 20 has a running member 52.

The running members 46, 48, 50 and 52 are guided along the control curves 42 and 44. The running members 46, 48, 50, 52 are in the form of spheres, in particular hollow spheres, which are mounted on the rear sides of the pistons 14, 16, 18 and 20 so as to be freely rotatable in all spatial directions, in the manner of a ball-and-socket mounting. The cross-sectional contour of the control curves 42 and 44 is correspondingly adapted to the spherical outer contour of the running members 46, 48, 50 and 52.

During the operation of the pivoting piston machine 10, the curve element 40 revolves about an axis of rotation 54 in the housing 12. The control curves 42 and 44 are designed such that, during the revolving movement of the curve element 40 about the axis of rotation 54, the pivoting movements of the pistons 14, 16, 18 and 20 are derived from the revolving movement of the curve element 40.

The curve element 40 is mounted in the housing by means of two ring-shaped bearings 56 and 58 so as to be rotatable in the housing 12 about the axis of rotation 54.

The pistons 14, 16, 18 and 20 do not revolve about the axis of rotation 54, but rather are accommodated in the housing 12 in static fashion, with the exception of their pivoting capability.

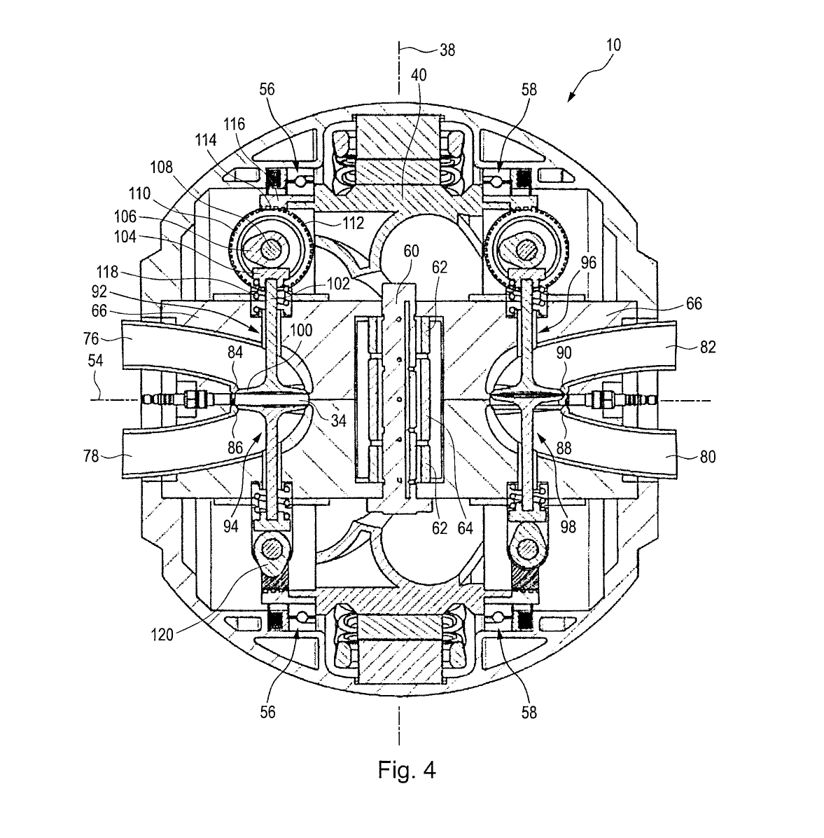

FIG. 4 shows a bearing journal 60 on which a fork-shaped bearing section 62 of the pair composed of the pistons 16 and 20 and a bearing section 64 of the pair composed of the pistons 14 and 18 are mounted so as to be rotatable about the pivot axis 38.

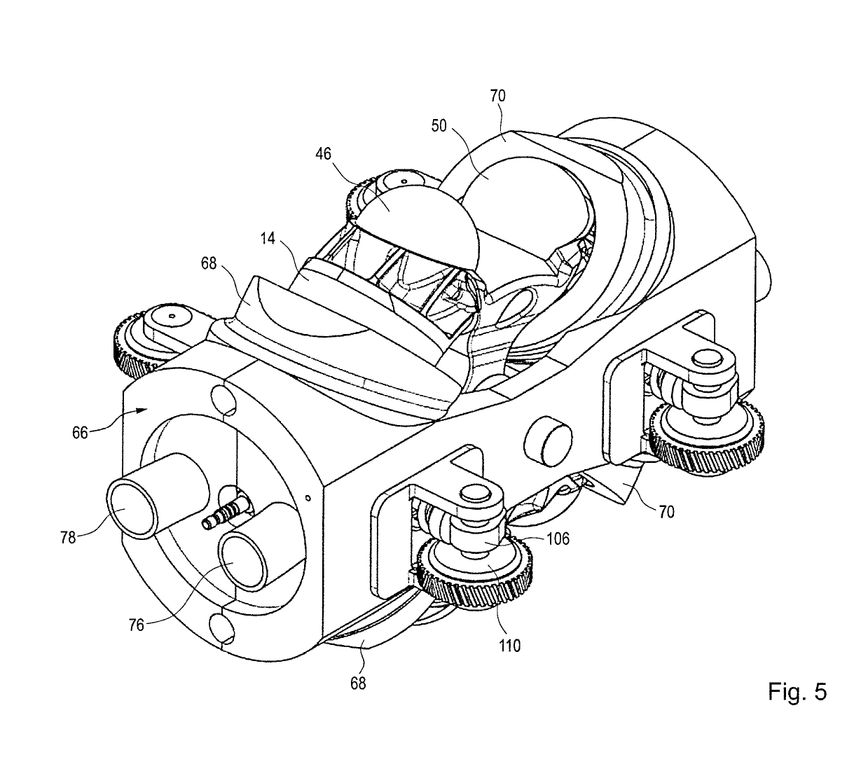

The pistons 14, 16, 18 and 20 are accommodated in the housing in a stator or piston cage 66, which is shown in FIG. 5 in the state dismounted from the housing 12. To the piston cage 66 there is fastened a two-part guide sleeve 68 in which the pistons 14 and 16 are movable in sliding fashion, and a further two-part guide sleeve 70 serves for accommodating the pistons 18 and 20, wherein the pistons 18 and 20 are movable in sliding fashion in the guide sleeve 70. The pistons 14 and 16 are sealed off with respect to the guide sleeve 68 by means of O-ring seals, as shown for a seal arrangement 72 for the piston 14 in FIG. 2. The same applies to the pistons 18 and 20 in the guide sleeve 70.

Further details of the pivoting piston machine 10, in particular the gas exchange control thereof and the geometrical design of the end surfaces 26, 28, 30, 32 of the pistons 14, 16, 18, 20 will be described in more detail with reference to FIGS. 1 to 4 and the further FIGS. 5 to 8.

In FIG. 4, the pivoting piston machine 10 has an inlet 76 for the admission of working medium into the working chamber 34 and an outlet 78 for the discharge of working medium out of the working chamber 34. Admitted working medium may in particular be fresh air, which may be mixed with a fuel. Discharged working medium may be burned fuel-air mixture (exhaust gas). Likewise, the working chamber 36 is assigned an inlet 80 for the admission of working medium into the working chamber 36 and an outlet 82 for the discharge of working medium out of the working chamber 36. As can be seen from FIG. 4, the arrangement of the inlet 80 and of the outlet 82 for the working chamber 36 is inverted, through 180°, in relation to the arrangement of the inlet 76 and of the outlet 78 for the working chamber 34. This is owing to the fact that the sequence of the individual working strokes of intake, compression, expansion and exhaust in the working chamber 36 takes place with a 180° phase offset in relation to the working chamber 34.

As per FIG. 4, the inlets and outlets 76, 78, 80, 82 run through the housing 12 and through the stator or piston cage 66. As per FIG. 4 and FIG. 1, the inlet 76 has a mouth 84 which is arranged in the working chamber 34.

Separately from the mouth 84, the outlet duct 78 has a mouth 86, which is likewise arranged in the working chamber 34. The mouth 86 is not visible in FIGS. 1 to 3, but is visible in FIG. 4. The mouths 84 and 86 are spaced apart from one another, and arranged opposite one another, in the working chamber 34, and are both situated between the end surfaces 26 and 28 of the pistons 14 and 16.

The inlet 80 has a mouth 88, and the outlet 82 has a mouth 90, which are arranged in the working chamber 36 between the end surfaces 30 and 32 of the pistons 18 and 20. The mouths 88 and 90 are also separated from one another, and are situated opposite one another in the working chamber 36.

In a preferred installation position of the pivoting piston machine 10, for example in a vehicle, the pistons 14, 16, 18, 20 are arranged so as to lie horizontally, such that the opening planes of the mouths 84, 86, 88, 90 lie horizontally, as shown for example in FIG. 4.

The inlet 76 into the working chamber 34 is assigned a closing element 92 for opening up and closing off the inlet 76. The outlet 78 from the working chamber 34 is assigned a closing element 94 for closing off and opening up the outlet 78. The inlet 80 is assigned a closing element 98 for closing off and opening up the inlet 80, and the outlet 82 is assigned a closing element 96 for opening up and closing off the outlet 82.

The closing elements 92, 94, 96 and 98 are each in the form of tulip valves, such as are commonly used in engines.

Since the closing elements 92, 94, 96 and 98 can be and preferably are of identical form, only the closing element 92 and the drive thereof will be described in more detail below. The following description thus also applies to the closing elements 94, 96 and 98 and the drives thereof.

The closing element 92 has a valve disk 100, which is arranged in the mouth 84 of the inlet 76 and which interacts sealingly with a valve seat formed at the mouth 84. FIGS. 1 to 3 show a bottom side of the valve disk 100 and the edge of the mouth 84. As can be seen from FIGS. 2 and 3, the valve disk extends parallel to the pivoting plane of the pistons 14 and 16 and perpendicular to the pivot axis 38.

The valve disk 100 is adjoined by a valve drive shank 102 which, as per FIG. 4, extends parallel to the pivot axis 38. The valve drive shank 102 extends in this case through the stator or piston cage 66. At its end which faces away from the valve disk 100, the valve drive shank 102 has a control head 104, which interacts with a cam 106. The control head 104, together with the valve drive shank, forms a plunger. The cam 106 is connected via a camshaft 108 to a toothed wheel 110. The toothed wheel 110 has a toothing 112 which is formed substantially as a transverse toothing. The toothing 112 meshes with a toothing 114, which is more clearly visible in the view in FIGS. 2 and 3, of a toothed ring 116 which is fixed to the curve element 40. The toothing 114 of the toothed ring 116 is formed substantially as a longitudinal toothing. As the curve element 40 revolves about the axis of rotation 54, the meshing engagement of the toothed ring 116 with the toothed wheel 112 effects a rotation of the camshaft 108 and thus of the cam 106, whereby the closing element 92 is transferred from its closed position into the open position in a manner dependent on the rotational position of the cam 106. The return of the closing element 92 into its closed position is effected by means of a compression spring 118, which is supported at one side on the plunger 102/104 and at the other side on the piston cage 66. The direction of movement of the closing element 92 during the opening and closing is parallel to the pivot axis 38.

Since the four working strokes of intake, compression, expansion and exhaust are to take place, in accordance with the 4-stroke principle, during one full revolution of the curve element 40 about the axis of rotation 54, the number of teeth of the toothing 114 is equal to the number of teeth of the toothing 112.

A cam 120 which interacts with the closing element 94 is rotationally offset with respect to the cam 106 by an angle of 90°, wherein the cam 120 controls the closing element 94 for the purposes of closing off and opening up the outlet 78. The rotational movement of the cam 120 is furthermore likewise generated by the toothed ring 116 on the curve element.

To permit an adjustment of the opening and closing times of the closing elements 92 and 94 in a manner dependent on load and/or rotational speed, the angular position of the cam 106 relative to the toothing 112 of the toothed wheel 110 is settable or adjustable, wherein the same applies to the cam 120, the angular position of which relative to the toothing of the toothed wheel assigned thereto is settable or adjustable. Here, the setting of the angular positions may be performed in a purely mechanical manner by means of a play, or may be performed by electrical-electronic means. Use may be made in particular of adjustment mechanisms such as are conventional in engine construction.

As emerges in FIG. 5, the toothed wheel 110 with the cam 106 is mounted on the piston cage 66. The same applies to the toothed wheels of the valve drives for the closing elements 94, 96 and 98.

FIG. 4 shows the two closing elements 92 and 94 in their mutual closed position. In said mutual closed position, the two valve disks of the closing elements 92, 94 are situated opposite one another and are spaced apart from one another, wherein the spacing between those sides of the two valve disks which face toward one another amounts to less than 1 cm, preferably at most 5 mm. When the pistons 14 and 16 have been moved toward one another to a maximum extent, the space between the two valve disks of the closing elements 92 and 94 forms the minimum volume of the working chamber 34.

FIG. 4 furthermore shows, by way of example, the closing element 98 in its maximum open position, whereas the closing element 96 is closed. The individual valve positions will be described in more detail further below.

The arrangement of the mouths 84 and 86 in the working chamber 34 between the end surfaces 26 and 28 of the pistons 14 and 16 makes it possible, as described below, for the end surfaces 26 and 28 to be provided with a particularly advantageous geometrical shape, as will be described below.

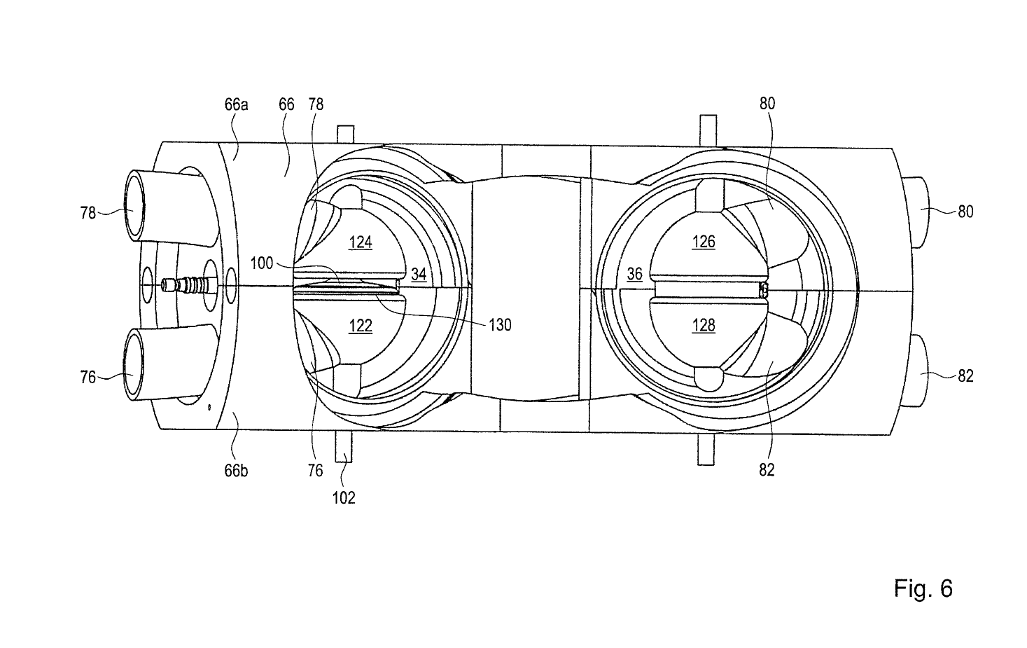

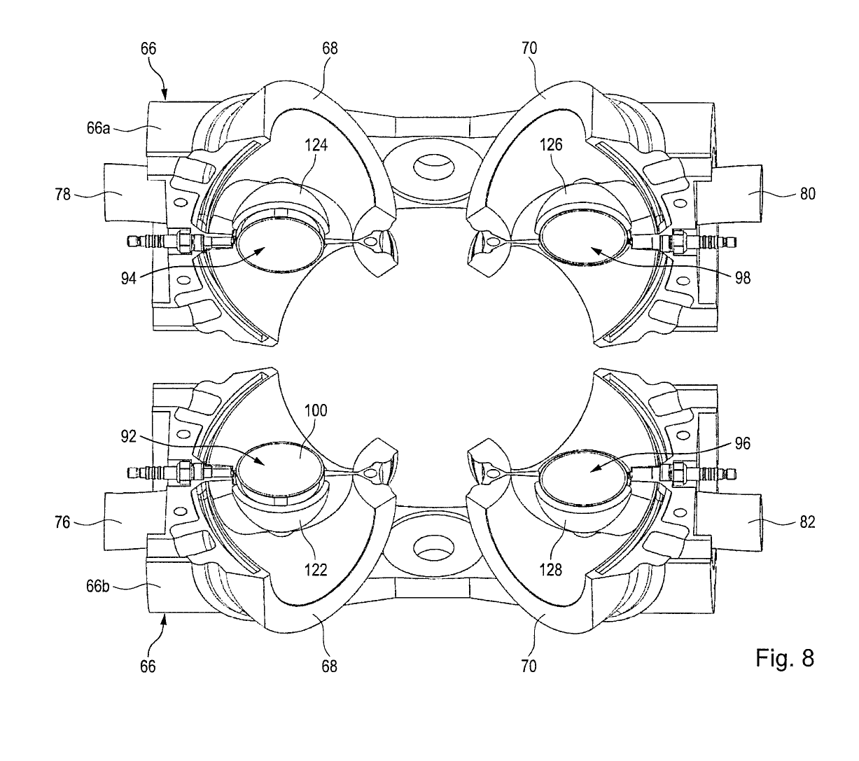

FIGS. 6 and 8 firstly show the piston cage 66 without the pistons 14, 16, 18 and 20 and without the guide sleeves 68 and 70. The piston cage 66 is assembled from two halves 66a and 66b, wherein FIG. 6 shows the halves 66a and 66b in the connected-together state, and FIG. 8 shows the halves 66a and 66b separated from one another.

As can be seen in particular from FIG. 6, the piston cage 66 has, on the outer side, bell-shaped sections 122, 124, 126 and 128 of convex form, wherein the bell-shaped section 122 belongs to the inlet 76, the bell-shaped section 124 belongs to the outlet 78, the bell-shaped section 126 belongs to the inlet 80 and the bell-shaped section 128 belongs to the outlet 82. The bell-shaped sections 122, 124, 126 and 128 are in this case situated in the working chamber 34 and in the working chamber 36 respectively. The bell-shaped sections 122, 124, 126, 128 are preferably formed integrally with the rest of the body of the piston cage 66. Furthermore, said bell-shaped sections may, in their walls, have coolant ducts through which cooling medium can be conducted.

An outer contour of the bell-shaped sections 122, 124, 126, 128 is of substantially hemispherical-shell-shaped form, such that the two bell-shaped sections 122, 124 together substantially form a spherical shell shape, in the same way as the two bell-shaped sections 126 and 128.

Here, as shown for an opening 130 of the bell-shaped section 122, the working-chamber-side openings of the bell-shaped sections 122, 124, 126, 128 form the mouth of the respective inlet or outlet, wherein the opening 130 forms the mouth of the inlet 76 in FIG. 6. Here, the edge of the opening 130 forms the valve seat for the valve disk 100 of the closing element 92. Here, the valve drive shank 102 likewise extends through the bell-shaped section 122.

FIG. 8 shows the respective valve disks in the respective openings of the bell-shaped sections 122, 124, 126, 128, as shown for the valve disk 100 in the opening of the bell-shaped section 122. Here, the valve disks are shown, in part, in an open position, such as the valve disk 100 or the valve disk in the bell-shaped section 124, whereas the valve disks in the bell-shaped section 126, 128 are shown in their closed position.

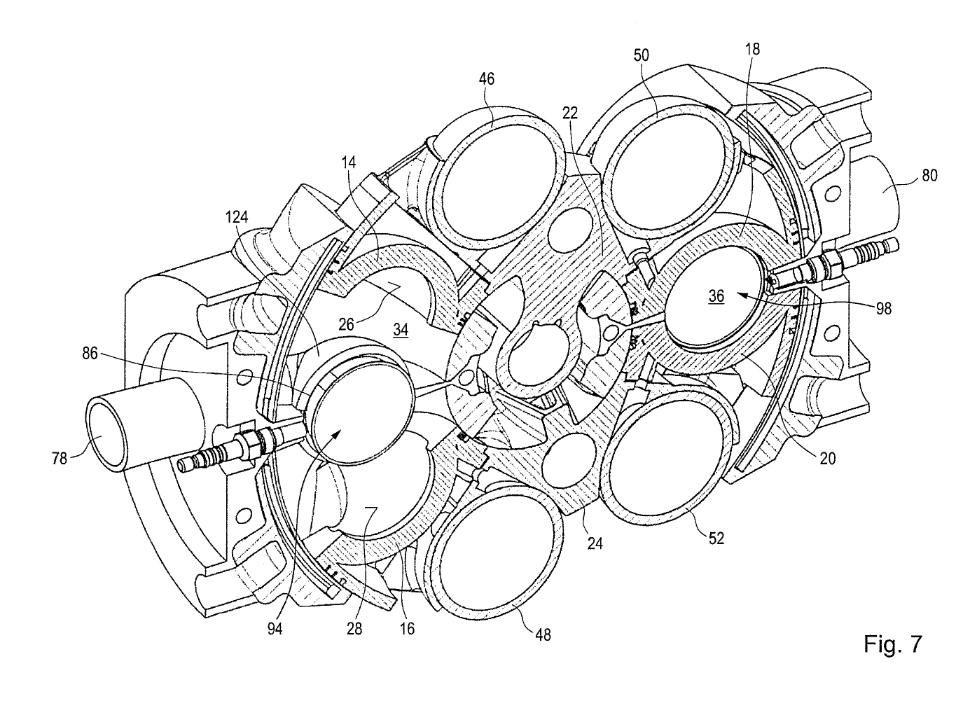

As can be seen most clearly from FIG. 7, the end surfaces 26, 28 of the pistons 14, 16 are concavely curved and are adapted to the outer contour of the bell-shaped section such that the end surfaces 26 and 28 surround the bell-shaped section 124 in a form-fitting manner when the pistons 14 and 16 have been pivoted toward one another to a maximum extent, and the working chamber 34 correspondingly has its minimum volume. It is self-evident that, in FIG. 7, owing to the sectional illustration, in each case only half of the pistons 14 and 16 is shown, and that the bell-shaped section 122 situated opposite the bell-shaped section 124 as per FIG. 6 is not visible in FIG. 7.

For the pistons 18 and 20, FIG. 7 shows the position in which they have been pivoted toward one another to a maximum extent (TDC), in which the end surfaces 30 and 32 of said pistons surround the bell-shaped section 126 (and correspondingly the oppositely situated bell-shaped section 128) in a form-fitting manner. Furthermore, the end surfaces 26, 28, 30, 32 are also adapted in terms of shape to the respective circular circumferential contour of the valve disks.

The end surfaces 26, 28 of the pistons 14, 16 (and the same applies to the end surfaces 30, 32 of the pistons 16, 18) together thus form a hollow-spherical-shell-like structure, which has the advantage that, proceeding from the TDC position of the pistons (as shown for the pistons 18 and 20 in FIG. 7), the working chamber 34 and the working chamber 36 respectively open in the manner of a hollow sphere. In particular in the case of the closing elements 92 and 98 assigned to the inlets 76 and 80, the opening thereof for the admission of working medium, in particular fresh gas, gives rise, owing to the arrangement of the mouths 84 and 88 provided in the working chambers 34 and 36, to a central-circumferential admission of the working medium through the ring-shaped gap between the respective mouth 84, 88 and the valve disk, and to a distribution and propagation of the working medium which is uniform in all directions of the working chambers 34 and 36, during the opening of the closing elements 92 and 98. During the working stroke of the expansion after the ignition of a fresh air-fuel mixture, the geometry of the end surfaces 26, 28 and 30, 32 yields an ideal combustion chamber.

The respective contour of the end surfaces 26, 28, 30 and 32 of the pistons 14, 16, 18 and 20 is in this case also adapted to the outer contour of the circumferential edge of the valve disks of the closing elements 92, 94, 96, 98 such that the end surfaces 26, 28 surround the valve disks of the closing elements 92, 94 in a form-fitting manner, and the end surfaces 30 and 32 of the pistons 18 and 20 surround the valve disks of the closing elements 96 and 98 in a form-fitting manner, when the working chamber 34 or 36 respectively has its minimum volume.

It can also be seen from FIG. 4 that the mouths 84 and 86 of the inlet 76 and of the outlet 78 respectively and the valve disks of the closing elements 92 and 94, in their mutual closed position, are arranged spaced apart from one another in the working chamber 34 symmetrically with respect to a geometric axis which runs centrally through the working chamber 34 and perpendicular to the pivot axis 38, wherein said geometric axis in this case coincides with the axis of rotation 54. The same applies to the mouths 88 and 90 of the inlet 80 and of the outlet 82 in the working chamber 36.

The end surfaces 26, 28 surround the bell-shaped sections 122 and 124, in their position in which they have been pivoted toward one another to a maximum extent (TDC position), with a spacing of the bell-shaped sections 122, 124 of preferably at most 0.5 mm. The same applies to the end surfaces 30 and 32 of the pistons 18 and 20 in relation to the bell-shaped sections 126 and 128.

In the TDC position of the pistons 14, 16 and 18, 20, the minimum volume of the working chamber 34 and 36 respectively is defined by the space between those sides of the valve disks of the closing elements 92, 94 and 96, 98 respectively which face toward one another.

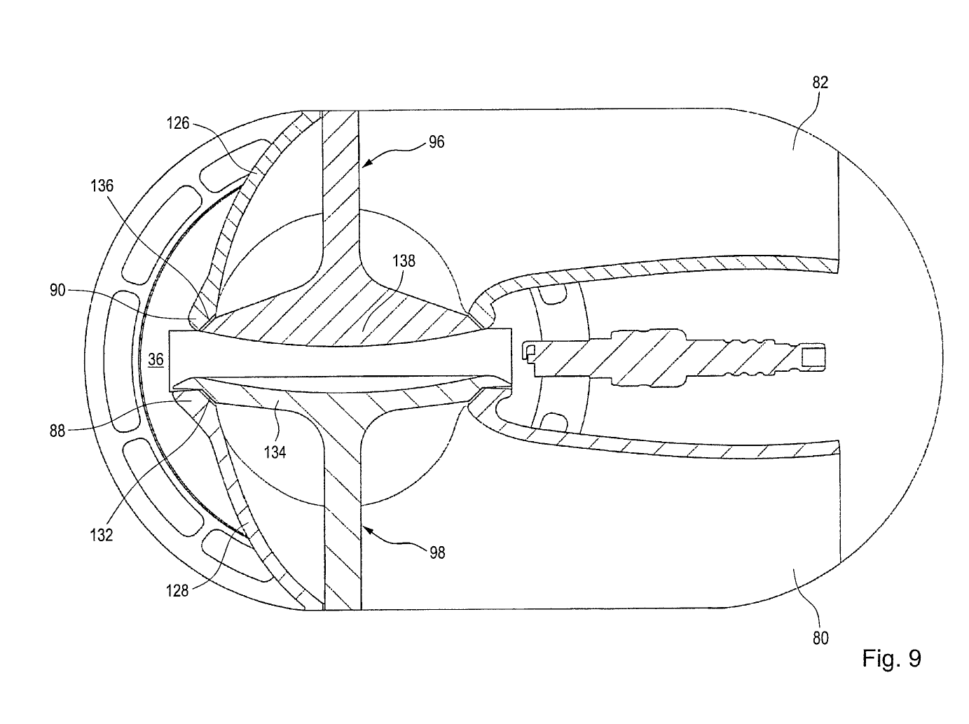

The gas exchange control arrangement of the pivoting piston machine 10 will be described below with reference to FIGS. 9 to 12. Here, the description will be given on the basis of the closing elements 96 and 98 in the working chamber 36, which are assigned to the outlet 82 and the inlet 80. In FIGS. 9 to 12, the valve seat 132 provided at the mouth 88 of the inlet 80 for the valve disk 134 of the closing element 98 is illustrated in more detail, as is the valve seat 136 at the mouth 90 of the outlet 82, with which the valve disk 138 interacts.

It can also be seen from FIG. 9 that the valve disk 138 of the closing element 96 for the outlet 82 has a slightly convex curvature, whereas the valve disk 134 for the closing element 98 for the inlet 80 has a slightly concave curvature.

FIG. 9 shows the closing elements 96 and 98 in their mutual closed position, in which both the inlet 80 and the outlet 82 are closed.

The mutual closed state of the closing elements 96 and 98 as per FIG. 9 is assumed for example during the working stroke of the expansion (work) or compression.

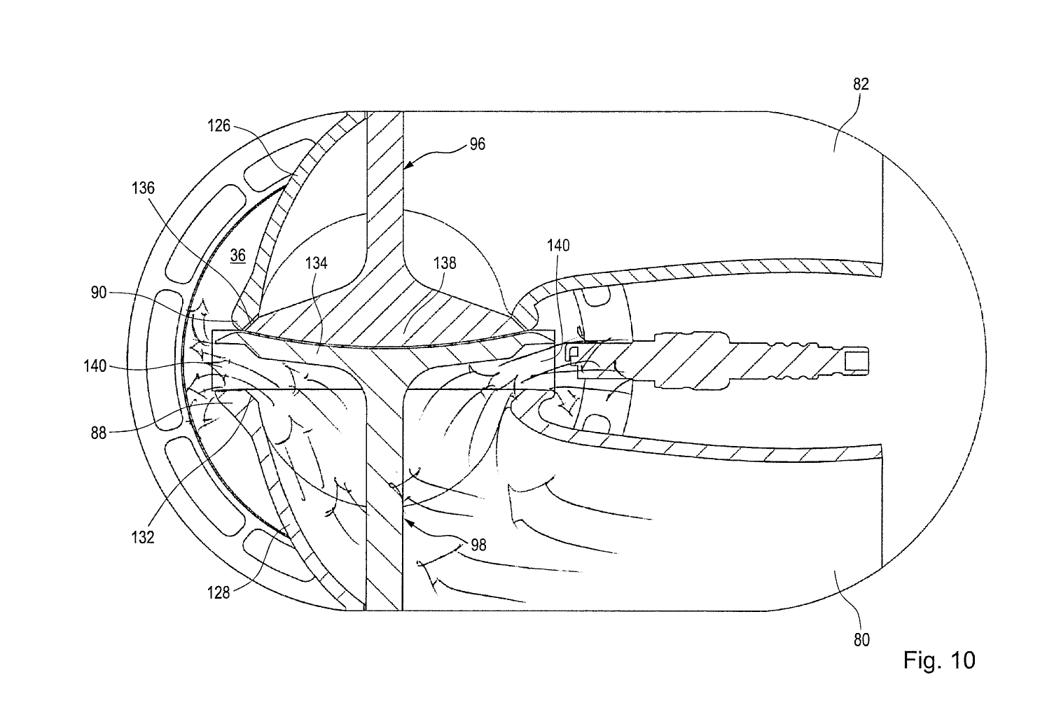

FIG. 10 shows the gas exchange control arrangement in an operating state in which the closing element 98 is fully open, whereas the closing element 96 is closed. It is now possible for working medium, for example fresh air, to flow into the working chamber 36 (as indicated by flow arrows) via the ring-shaped gap 140 between the valve disk 134 and the mouth 88 of the inlet 80, and to distribute and propagate in a particularly uniform manner in the working chamber 36, because the ring-shaped gap 140 opens in a central-circumferential manner in the working chamber 36. The distances covered by the admitted working medium are in this case approximately equal in all directions of the flow.

In the preferred installation position of the pivoting piston machine 10 already mentioned above, in which the pistons 14, 16, 18, 20 are arranged horizontally, that is to say the pivot axis 38 runs vertically, the working medium flows substantially horizontally through the ring-shaped gap 140 into the working chamber 36, which is promoted by the shaping of the edge of the valve disk 134 as illustrated in FIG. 10.

The gas exchange state as per FIG. 10 is assumed during the working stroke of the intake, for example of fresh air (with or without fuel).

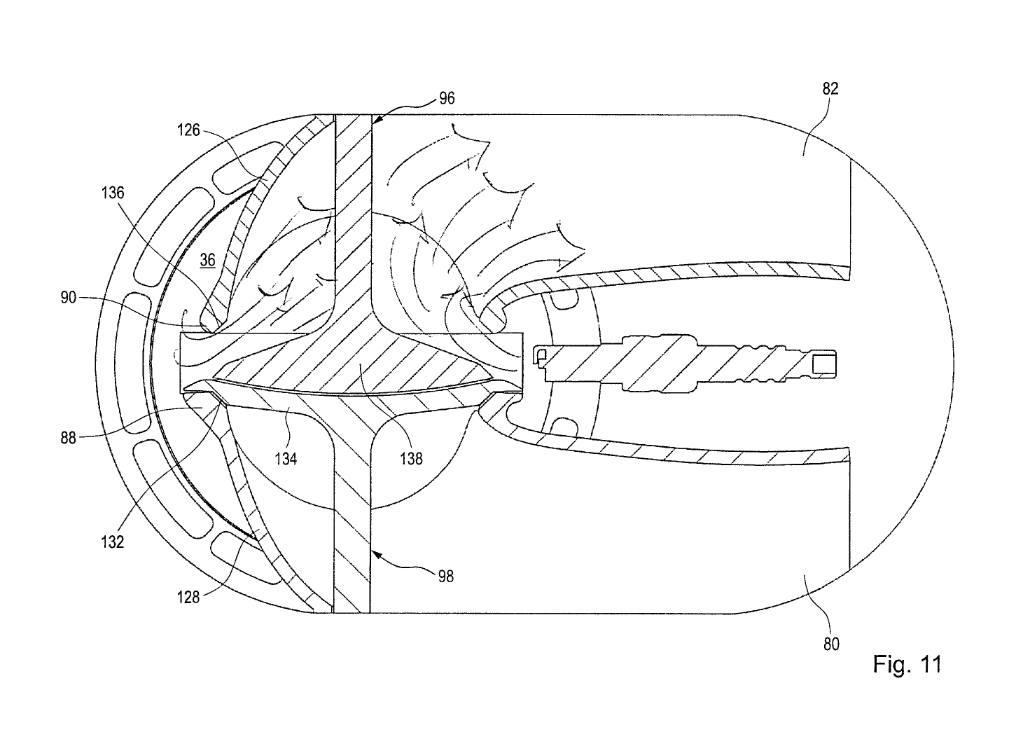

FIG. 11 shows an operating state of the gas exchange control arrangement in which the closing element 96 is fully open, whereas the closing element 98 is closed. This gas exchange state is assumed during the working stroke of the discharge or exhaust of burned combustion mixture. Burned combustion mixture is discharged particularly rapidly via the ring-shaped gap 140, and the working chamber 36 is correspondingly evacuated very rapidly and completely.

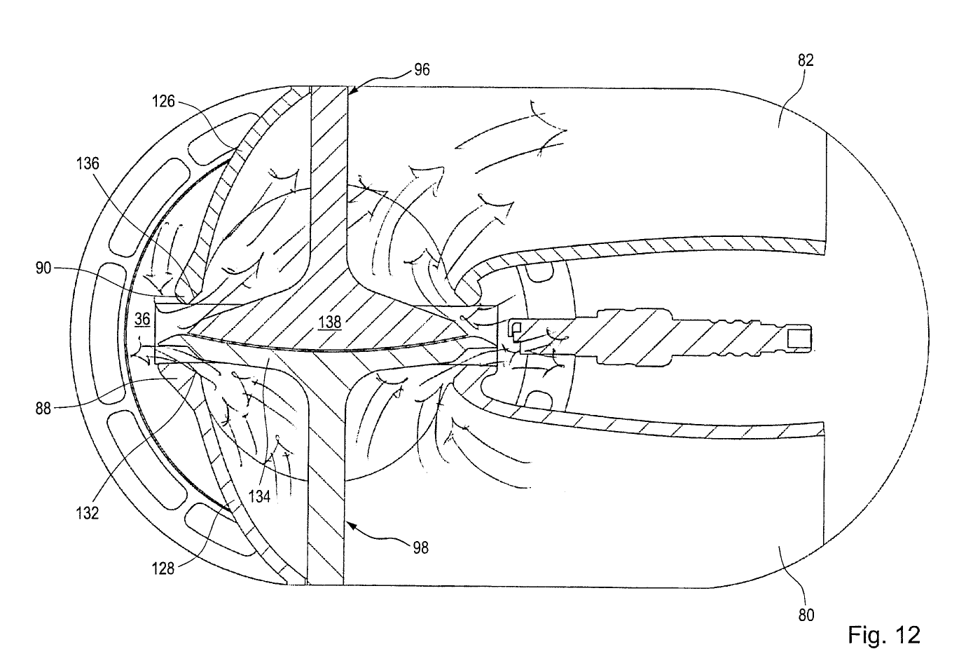

FIG. 12 shows an operating state of the gas exchange control arrangement in which both the closing element 96 and the closing element 98 are partially open. This operating state of the gas exchange control arrangement is also referred to as overlap. By means of the overlap, it is for example possible to realize internal exhaust gas recirculation, which is expedient as a temperature-lowering measure for nitrogen oxide reduction. Furthermore, an overlap of the opening of the inlet 80 and of the outlet 82 can have the effect that the outflowing exhaust gas entrains the fresh gas flowing in via the inlet 80, and that the working chamber is thus thoroughly purged. As a result, more fresh gas is situated in the working chamber 36, whereby greater torque and greater power can be achieved.

According to further aspects of the pivoting piston machine 10, the latter has ignition means assigned to the working chambers 34 and 36, for example in the form of ignition plugs 150 and 152. Furthermore, injection means (not illustrated in any more detail) for fuel are provided, for example so as to open into the inlets 76 and 80.

Whereas it has been described above that both working chambers 34 and 36 are utilized as combustion chambers, it is likewise possible, for example, for only the working chamber 34 to be utilized as a combustion chamber, whereas the working chamber 36 is utilized as a compressor for compressing air. In this case, the ignition means at the working chamber 36 can be omitted. The air that is compressed in the compressor (working chamber 36) may for example be fed to the working chamber 34, such that the pivoting piston machine 10 experiences supercharging, as in the case of a turbocharger.

As already mentioned above, the pivoting piston machine 10 is preferably equipped with an electromotive part, which is denoted in FIG. 3 by the general reference designation 160. The electromotive part 160 has in this case a rotor 162 with a coil which is fixedly connected to the curve element 40. Furthermore, the electromotive part 160 has a stator 164, which is fixedly connected to the housing 12 and which interacts with the rotor 162 as the rotor 162 revolves about the axis of rotation 54. The electromotive part may in this case serve as an electric motor, that is to say as an electric drive instead of or in addition to the drive energy provided by the combustion-engine part of the pivoting piston machine 10, or may serve as a generator for providing electrical energy, for example for the purposes of charging the vehicle battery.

What is claimed is:

1. A pivoting piston machine, comprising
a housing,
a first piston and a second piston arranged in the housing, the first and second pistons being pivotable away from one another and toward one another about a pivot axis,
the first piston having a first end surface and the second piston having a second end surface,
a working chamber for a working medium arranged between the first end surface and the second end surface, the working chamber increasing and decreasing in size in alternating fashion during pivoting of the first piston and of the second piston,
an inlet having an inlet mouth for admission of working medium into the working chamber, and an outlet having an outlet mouth for discharge of working medium out of the working chamber, the inlet and the outlet opening into the working chamber,
a closing element for closing and opening up one of the inlet or the outlet, the closing element having a valve disk interacting with a valve seat,
wherein at least one of the inlet mouth and the outlet mouth is arranged within the working chamber between the first end surface and the second end surface, and wherein the valve seat and the valve disk are arranged at one of the inlet mouth or the outlet mouth.

2. The pivoting piston machine as claimed in claim 1, wherein the valve disk extends parallel to a pivot plane of the first and second pistons.

3. The pivoting piston machine as claimed in claim 1, wherein the valve disk is movable parallel to the pivot axis for closing and opening-up of the mouth.

4. The pivoting piston machine as claimed in claim 1, wherein a respective contour of the first and second end surfaces is adapted to an outer contour of a circumferential edge of the valve disk such that the first and the second end surfaces surround the valve disk in a form-fitting manner when the working chamber has its minimum volume.

5. The pivoting piston machine as claimed in claim 1, further comprising a piston cage arranged in the housing, wherein the first piston and the second piston are arranged in the piston cage, wherein the piston cage has a bell-shaped section, a working-chamber-side opening of which forms one of the inlet mouth and the outlet mouth.

6. The pivoting piston machine as claimed in claim 5, wherein the first end surface and the second end surface are concavely curved and are adapted to an outer contour of the bell-shaped section, such that the first and the second end surfaces surround the bell-shaped section in a form-fitting manner when the working chamber has its minimum volume.

7. The pivoting piston machine as claimed in claim 1, wherein the closing element is a first closing element for closing and opening up the inlet mouth, the valve disk is a first valve disk, and the valve seat is a first valve seat, and further comprising a second closing element for closing and opening up the outlet mouth, wherein the second closing element has a second valve disk which interacts with a second valve seat at the outlet mouth, wherein the second valve disk is arranged so as to be situated opposite the first valve disk.

8. The pivoting piston machine as claimed in claim 7, wherein the first valve disk and the second valve disk are, in their mutual closed position, arranged spaced apart from one another symmetrically with respect to a geometric axis which runs centrally through the working chamber and perpendicular to the pivot axis.

9. The pivoting piston machine as claimed in claim 8, wherein a spacing of the first valve disk from the second valve disk in the mutual closed position amounts to less than approximately 1 cm.

10. The pivoting piston machine as claimed in claim 8, wherein a spacing of the first valve disk from the second valve disk in the mutual closed position amounts to less than approximately 0.8 cm.

11. The pivoting piston machine as claimed in claim 8, wherein a spacing of the first valve disk from the second valve disk in the mutual closed position amounts to approximately 0.5 cm.

12. The pivoting piston machine as claimed in claim 1, further comprising a ring-shaped curve element arranged in the housing, the curve element having a control curve, wherein the curve element can revolve in the housing about an axis of rotation which runs perpendicular to the pivot axis, wherein the first piston and the second piston have in each case one running member, which running members are guided along the control curve in order to derive a pivoting movement of the first and second pistons from a revolving movement of the curve element.

13. The pivoting piston machine as claimed in claim 12, further comprising a valve controller for controlling the closing element, which valve controller is formed as a cam-type controller with a rotatable cam which interacts with a plunger connected to the valve disk, wherein the cam is driven by the curve element.

14. The pivoting piston machine as claimed in claim 13, wherein the curve element has a toothed ring equipped with a first toothing, and wherein the cam has a toothed wheel equipped with a second toothing, wherein the first toothing is in meshing engagement with the second toothing.

15. The pivoting piston machine as claimed in claim 13, wherein the valve controller is adjustable for the purposes of setting at least one of a closing time, an opening-up time, and a stroke of the closing element in a manner dependent on at least one of load and rotational speed.

16. The pivoting piston machine as claimed in claim 14, wherein an angular position of the cam relative to the toothed wheel is adjustable.
